(19) United States
(12) Patent Application Publication
(10) Pub. No.: US 2016/0340050 A1
(43) Pub. Date: Nov. 24, 2016

(54) MOLDED INSERT FOR ENHANCED PULLL-OUT STRENGTH

(71) Applicant: GOODRICH CORPORATION, Charlotte, NC (US)

(72) Inventors: Ryan Schmidt, Gilbert, AZ (US); Nick Ruegsegger, Glendale, AZ (US)

(73) Assignee: GOODRICH CORPORATION, Charlotte, NC (US)

(21) Appl. No.: 14/716,425

(22) Filed: May 19, 2015

(51) Int. Cl. B64D 25/14; E04C 2/28; E04B 2/00; F16B 37/12; E04C 2/34

(52) U.S. Cl. CPC B64D 25/14; F16B 37/122; E04C 2/34; E04C 2/44; E04C 2/28; E04C 2002/001

(57) ABSTRACT

An insert includes a shaft. The shaft includes a first end, a second end, and an external surface and an internal surface extending between the first end and the second end. The internal surface defines a passage through the shaft. The insert further includes a base flange located at the first end of the cylindrical shaft and having a first diameter. The insert also incudes a first disc member having a second diameter smaller than the first diameter and located at the second end of the cylindrical shaft. The insert still further includes a second disc member having a third diameter smaller than the first diameter and located on the cylindrical shaft between the base flange and the first disc member.

### BACKGROUND

In an aircraft, emergency evacuation slides are stored in a composite structure called a packboard. Because the packboard is formed from a composite, the evacuation slide or any other component cannot be attached to the packboard by bolting or screwing directly into the composite packboard wall. An insert must be placed in the packboard for the screw or bolt to be threaded through.

These inserts are subjected to high sheer and tension loads. For example, when the emergency evacuation slide is deployed, wind can act on the slide causing it to move, which subjects the inserts to sheer and tension loads. Also, when passengers and crew jump onto the slide to exit the aircraft the inserts are subjected to high sheer and tension loads. Because these inserts are embedded within the packboard they can bear against the packboard structure which allows the insert to tolerate sheer loading quite well. Against tensile loads, however, inserts that are currently used can be challenged in providing good pull-out strength. There is a need, therefore, to improve the pull-out strength of inserts subjected to tensile loads.

### SUMMARY

According to one embodiment of the disclosure an insert includes a shaft. The shaft includes a first end, a second end, and an external surface and an internal surface extending between the first end and the second end. The internal surface defines a passage through the shaft. The insert further includes a base flange located at the first end of the cylindrical shaft and having a first diameter. The insert also incudes a first disc member having a second diameter smaller than the first diameter and located at the second end of the cylindrical shaft. The insert still further includes a second disc member having a third diameter smaller than the first diameter and located on the cylindrical shaft between the base flange and the first disc member.

According to a further embodiment of the disclosure a structure includes a composite panel. The composite panel includes a first surface, a second surface, and a bore extending between the first and second surfaces. An insert is positioned substantially between the first surface and the second surface of the composite panel. The insert includes a shaft. The shaft includes a first end, a second end, and an external shaft surface and an internal shaft surface extending between the first and second ends. The internal shaft surface defines a passage through the shaft. A base flange is located on the first end of the cylindrical shaft and is positioned on one of the composite panel first or second surfaces and has a first diameter. The insert also includes a first disc member located at the second end of the shaft and has a second diameter smaller than the first diameter. The insert also includes a second disc member located on the shaft between the base flange and the first disc member and has a third diameter smaller than the first diameter.

According to a further embodiment of this disclosure an emergency evacuation slide assembly for an aircraft includes a packboard compartment including a rear panel having an external surface and an internal surface, a plurality of lateral panels attached to the rear panel. Each of the lateral panels has an external surface and an internal surface. A bore extends between the internal and external surfaces of one of the panels. A fabric cover is attached to the plurality of lateral panels and forms a front surface of the packboard compartment. An insert is positioned substantially within the bore. The insert includes a shaft having a first end, a second end. The insert further includes an external shaft surface and an internal shaft surface extending between the first and second ends. The internal shaft surface defines a passage through the shaft. The insert further includes a base flange is located on the first end of the cylindrical shaft and positioned on one of the packboard panels. The base flange has a first diameter. The insert further includes a first disc member located at the second end of the shaft. The first disc member has a second diameter smaller than the first diameter. The insert also includes a second disc member located on the shaft between the base flange and the first disc member. The second disc member has a third diameter that is smaller than the first diameter. The assembly also includes an inflatable evacuation slide disposed within the packboard. The assembly also includes a threaded fastener engaging the threaded passage of the insert and extending through the fabric cover and evacuation slide to secure the cover and slide to the packboard.

### BRIEF DESCRIPTION OF THE DRAWINGS

FIG. 1 is a perspective view of an evacuation slide system incorporating features of the disclosure.

FIG. 2A is a perspective view of an insert having a base flange.

FIG. 2B is a side view of the insert of FIG. 2A.

FIG. 2C is a bottom view of the insert of FIG. 2B.

FIG. 3A is a perspective view of an insert having an external base flange and a first internal ring member configured to receive a countersunk screw head.

FIG. 3B is side view of the insert of FIG. 3A.

FIG. 4 is a sectional perspective view of the insert installed in a composite packboard.

### DETAILED DESCRIPTION

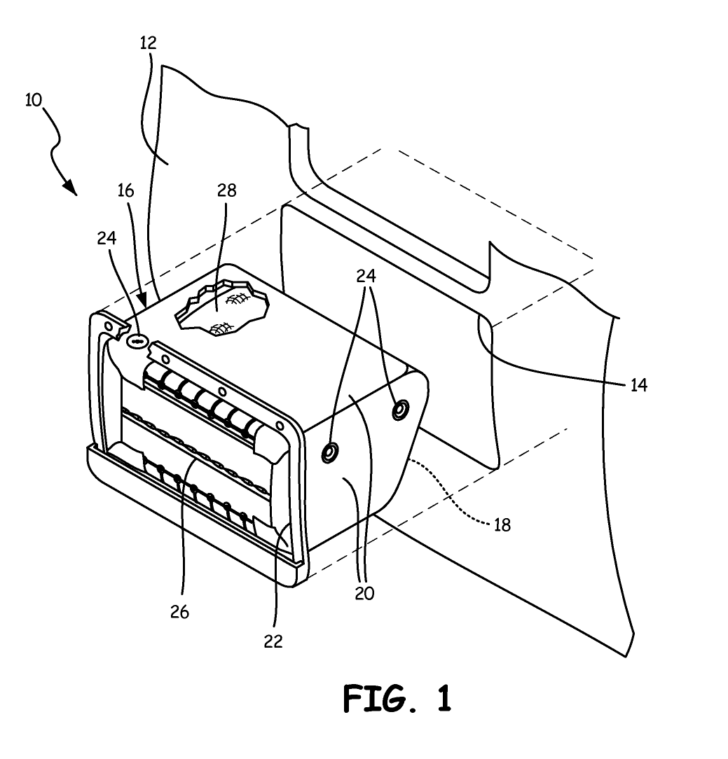

FIG. 1 is a perspective view of evacuation slide system 10. FIG. 1 illustrates fuselage 12, compartment 14, packboard 16, rear panel 18, lateral panels 20, front end 22, inserts 24, fabric cover 26, and evacuation slide 28.

Fuselage 12 of an aircraft includes compartment 14 to contain packboard 16. Packboard 16 is formed from a plurality of panels. The panels can be formed from a composite material. Of those panels forming packboard 16, lateral panels 20 extend from rear panel 18 and define front end 22. Rear panel 18 and lateral panels 20 each have an external and internal surface. Inserts 24 are shown disposed in lateral panels 20 of packboard 16. Evacuation slide 28 is located within packboard 16. Fabric cover 26 covers front end 22.

Packboard 16 can also be called a tub or a slide compartment. As described above, packboard 16 is formed from a plurality of panels 18 and 20. Panels 18 and 20 are generally formed from stacked plies of a solid laminate material. The solid laminate material can be selected from many materials. Examples of suitable materials include graphite fiber, glass fiber, boron fiber, silicon carbide fiber, epoxy composite, polyimide composite, aluminum composite, titanium composite, and alumina composite materials. Typically, the plies will sandwich a metal or composite honeycomb core materials such as phenolic coated aramid paper. Fabric cover 26 can be made from fire retardant coated nylon fabrics. Fabric cover 26 helps to retain evacuation slide 28 within packboard 16. If evacuation slide 28 is activated, then air will quickly be supplied to slide 28. As evacuation slide 28 expands it will rip through fabric cover 26 and continue to inflate until it is fully inflated. Inserts 24 help to attach fabric cover 26 and evacuation slide 28 to packboard 16. Inserts 24 are discussed in more detail below.

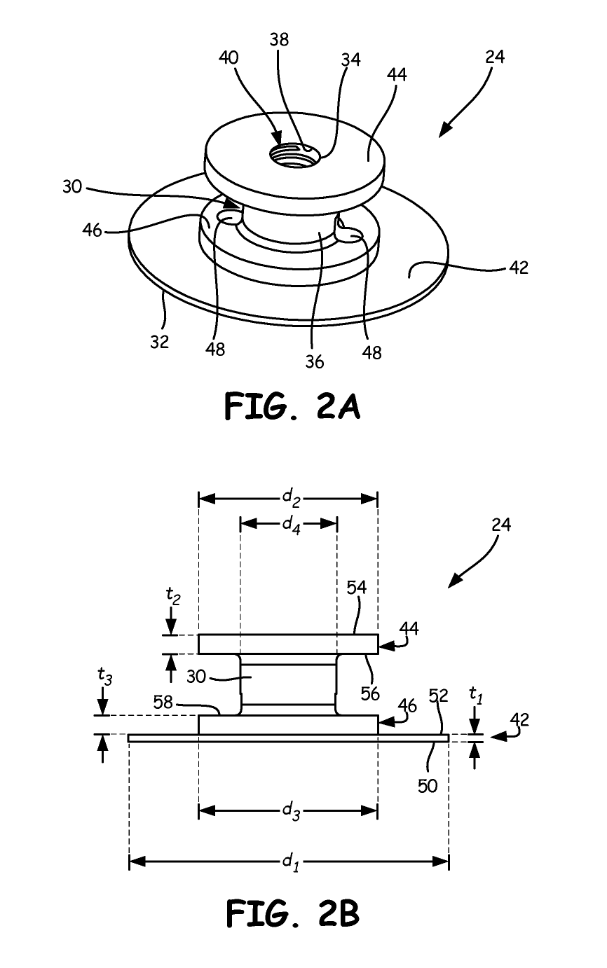

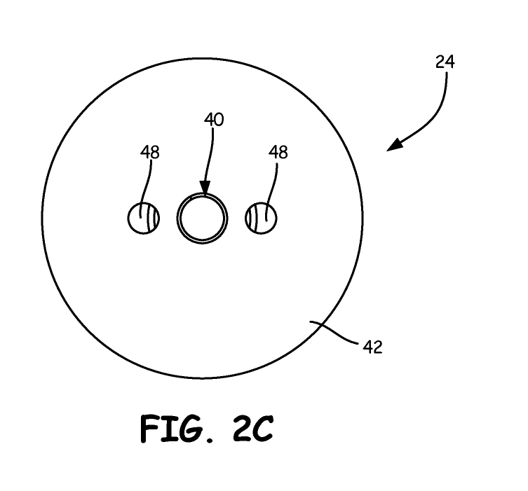

FIG. 2A is a perspective view of insert 24. Insert 24 includes shaft 30, first end 32, second end 34, shaft external surface 36, shaft internal surface 38, passage 40, base flange 42, first disc member 44, second disc member 46, and vents 48.

Shaft 30 is cylindrically shaped extends and from first end 32 to second end 34. Shaft external surface 36 and shaft internal surface 38 span between first end 32 and second end 34. Shaft internal surface 38 defines passage 40, which extends through shaft 30. Passage 40 can be threaded to accept a threaded connector such as a screw. The threading can conform to many industry standards. As non-limiting examples, the threading in passage 40 can conform to a 10-32 thread (5 mm×0.8 mm) or a ¼-28 thread (6 mm×1 mm). Alternatively passage 40 can be unthreaded to receive a bolt.

Base flange 42 is circular and is located on first end 32 of shaft 30. First disc member 44 is circular and is located on second end 34 of shaft 30. Second disc member 46 is also circular and is located on shaft 30 between base flange 42 and first disc member 44. In FIG. 2A, second disc member 46 is shown abutting base flange 42. In alternate embodiments, second disc member 46 can be located elsewhere along shaft 30 between base flange 42 and first disc member 44. Vents 48 extend through base flange 42 and second disc member 46. As shown, vents 48 extend in a direction parallel to passage 40 but in other embodiments vents 48 can extend through base flange 42 in other directions.

FIG. 2B is a side view of insert 24. FIG. 2B illustrates base flange 42, first disc member 44, and second disc member 46. Base flange 42 includes first surface 50 and second surface 52. First disc member 44 includes first surface 54 and second surface 56. Second disc member 46 includes first surface 58.

Base flange 42 has a thickness t₁, first disc member 44 has a thickness t₂, and second disc member 46 has a thickness t₃. As depicted thicknesses t₂ and t₃ are substantially equivalent to each other and are approximately three times greater than thickness t₁. In other embodiments of insert 24, thicknesses t₂ and t₃ can range from approximately one and half times greater to approximately five times greater than t₁. Alternatively, t₁ can range from approximately one and half times greater to approximately five times greater than t₂ or t₃. Thicknesses t₁, t₂, and t₃ can also be substantially equivalent to each other.

As depicted, base flange 42 has a diameter d₁ that is approximately two times greater that diameter d₂ of first disc member 44. In other embodiments d₁ can range from approximately one and a half times greater than d₂ to approximately five times greater than d₂. As further depicted, diameter d₂ of first disc member 44 is approximately equal to diameter d₃ of second disc member 46. Shaft 30 has a diameter d₄ that is less than any of diameters d₁, d₂, or d₃.

FIG. 2C is a bottom view of insert 24. As shown in FIG. 2C, vents 48 extend through base flange 42. Vents 48 extend in a direction parallel to passage 40. Vents 48 can also extend through second disc member 46 in a direction parallel to passage 40. In other embodiments of insert 24 vents 48 can extend through base flange 42 or second disc member 46 in directions other than parallel to passage 40.

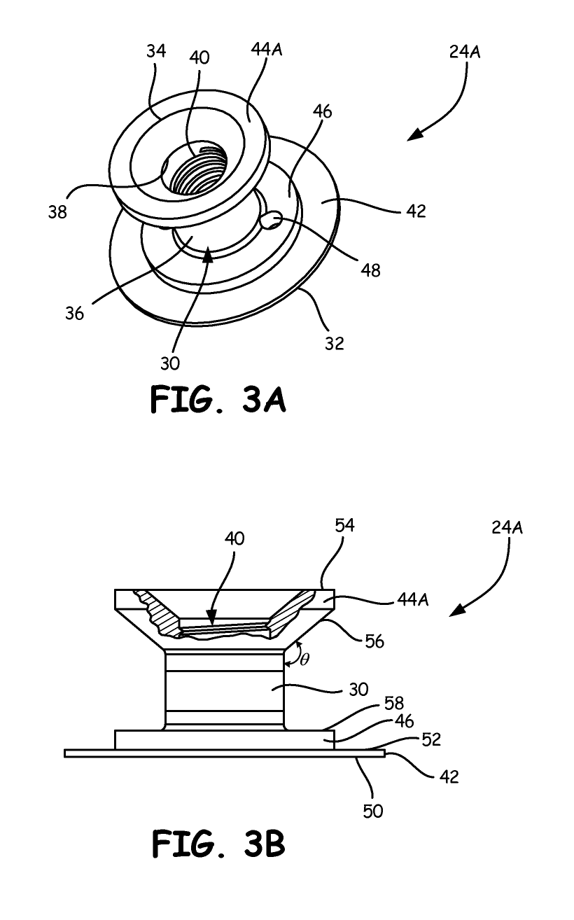

FIG. 3A is a perspective view of insert 24A. Insert 24A is substantially similar to insert 24. One difference between insert 24 and insert 24A is the shape of first disc member 44A. As depicted in FIG. 3A, first disc member 44A has a frustoconical shape and tapers towards second disc member 46.

FIG. 3B is a partial sectional side view of insert 24A. As illustrated, a portion of passage 40 extending through first disc member 44A also has a frustoconical shape. As shown in FIG. 3B, first disc member 44A tapers toward second disc member 46 at an angle θ of approximately 135 degrees. In other embodiments of insert 24A first disc member 44A can be tapered at angles ranging from about 100 degrees to about 150 degrees. This angle is generally dependent on the frustoconical angle of the countersunk screw used. The frustoconical shape of first disc member 44A allows first disc member 44A to receive a countersunk screw head.

Insert 24 or 24A has a unitary structure. Inserts 24 or 24A can be formed from many different types of materials. Non-limiting examples of suitable materials include stainless steel, aluminum, a composite material, or plastic. Insert 24 or 24A can also be constructed in a variety of different ways. For example, insert 24 or 24A can be machined, milled, or cast molded. Insert 24 or 24A can also be constructed through additive manufacturing methods.

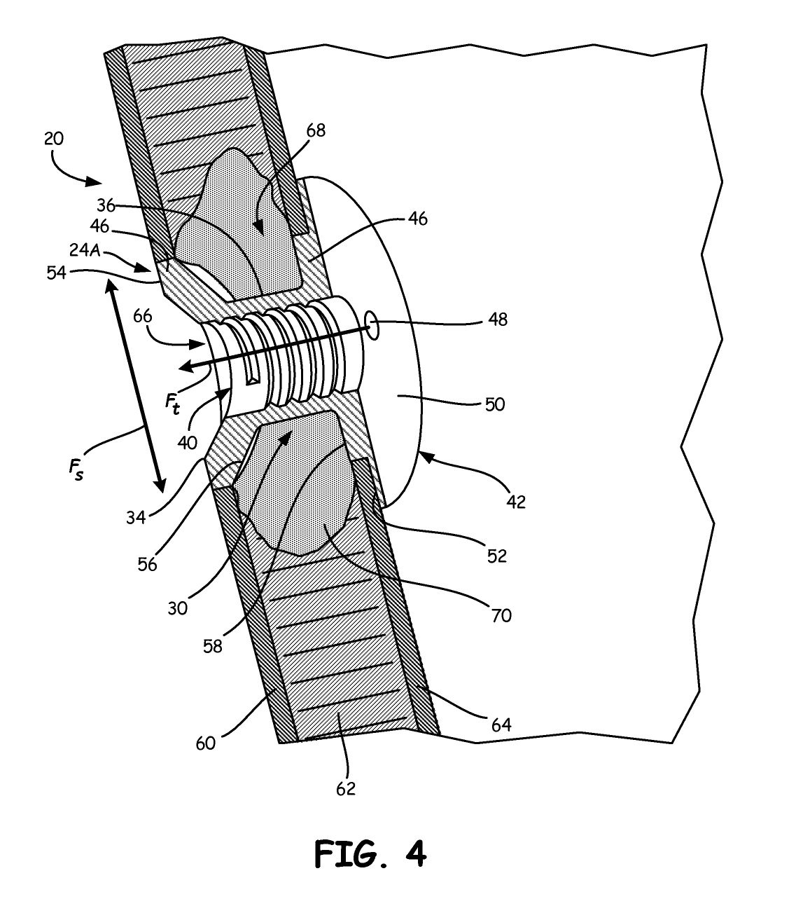

FIG. 4 is a sectional view illustrating lateral panel 20 of packboard 16 having insert 24A installed therein. Lateral panel 20 includes first ply 60, core 62, and second ply 64. FIG. 4 also illustrates bore 66, void 68, and potting material 70.

First ply 60 can be a single ply or a stack of plies. Second ply 64, similarly, can be a single ply or a stack of plies. First ply 60 defines the exterior surface of lateral panel 20 and is formed from solid laminate materials as described above with respect to FIG. 1. Core 62 defines the center of lateral panel 20 and is formed from a material described above with respect to FIG. 1 having a honeycomb structure. Second ply 64 defines the interior surface of lateral panel 20 and is formed from solid laminate materials.

Bore 66 is formed through lateral panel 20 as described in further detail below. As depicted, insert 24A is positioned within bore 66. Insert 24 can also be positioned within bore 66. First disc member first surface 54 is flush with the outer surface of first ply 60 and second disc member 46 is flush with second ply 64. As also depicted, base flange second surface 52 is positioned adjacent to the outer surface of second ply 64. Void 68 is formed between shaft external surface 36, first disc member second surface 56, second disc member first surface 58 and the perimeter of bore 65. Void 68 is filled with potting material 70.

In order to install insert 24A in lateral panel 20 (or any other location of packboard 16 such as rear panel 18), bore 66 is formed in lateral panel 20. Bore 66 is dimensioned to tightly fit diameters d₂ of first disc member 44A and diameter d₃ of second disc member 46 within first ply 60 and second ply 64, respectively. Through core 62 bore 66 is widened to a diameter greater than either d₁ or d₂. After bore 66 is formed, insert 24A is positioned therein. After insert 24A is positioned within bore 66 such that base flange 42 rests adjacent to the outer surface of second ply 64, potting material 70 is injected through one of vents 48. Potting material 70 is an adhesive such as an epoxy paste. Potting material 70 fills void 68. Potting material 70 is fed into one of vents 48 until potting material 70 exits the other vent 48; this indicates that void 68 is full. Potting material 70 adheres to insert 24A and core 62. This helps to anchor insert 24 within bore 66. Widening bore 66 through core 62 increases the available surface area for potting material 70 to adhere to, which can further help to anchor insert 24A within lateral panel 20.

After potting material 70 is injected into void 68, potting material 70 is left to cure. Once potting material 70 has cured, insert 24A can be used to attach components to packboard 16. Components are attached to packboard 16 by threading a screw through the component and then threading the screw through insert 24A.

As illustrated in FIG. 4, base flange 42 of insert 24A is positioned adjacent to the outer surface of second ply 64 of lateral panel 20. In that base flange 42 is adjacent to the outer surface of second ply 64, base flange 42 is located on the interior surface of lateral panel 20 and therefore the interior surface of packboard 16. Locating base flange 42 on the interior surface of packboard 16 can be useful for attaching certain components to packboard 16. For example, installing packboard 16 into compartment 14 can require attaching packboard 16 to a lifting apparatus. Positioning inserts 24 or 24A in packboard 16 allows for a secure connection between packboard 16 and the lifting apparatus. A secure connection is needed because as packboard 16 is lifted, a tensile force will be applied to insert 24 or 24A. Tensile forces impart a pull-out strain on insert 24 or 24A. Tensile force is represented by arrow Fₜ in FIG. 4. Arrow Fₜ shows the tensile force being exerted in a direction from second ply 64 to first ply 60. Tensile forces, therefore, cause base flange 42 to bear against second ply 64 in that insert 24 or 24A is pulled in the direction of the tensile force. In bearing against second ply 64, base flange 42 increases the pull-out strength of insert 24 or 24A by preventing insert 24 or 24A from being pulled through bore 66.

Insert 24 or 24A will also be exposed to sheer forces. Sheer forces causes insert 24 to bear against the interiors of first ply 60 and second ply 64. Specifically, first disc member 44 or 44A bears against the interior of first ply 60 and second disc member 46 bears against the interior of second ply 64. Sheer force is represented by arrow Fₛ in FIG. 4.

In another embodiment, the orientation of first ply 60 and second ply 64 is the opposite of that described above, such that first ply 60 defines the interior surface of lateral panel 20 and second ply 64 defines the exterior surface of lateral panel 20. In this orientation, base flange 42 is positioned on the exterior surface of lateral panel 20. This orientation of insert 24 or 24B can be used to install emergency evacuation slide 28.

To install evacuation slide 28 in packboard 16 a row of inserts 24 or 24A are installed along lateral panel 20, as described above, and near front end 22. A portion of evacuation slide 28 is positioned over first disc member 44 or 44A and a portion of fabric cover 26 is positioned over the portion of evacuation slide 28. A screw or bolt is threaded through fabric cover 26, evacuation slide 28, and passage 40. When the evacuation slide is deployed, insert 24 or 24A will be subject to sheer forces and tensile forces as described above. These forces can arise from passengers and crew jumping on the slide to evacuate the aircraft, wind acting on the deployed slide, or the force of emergency slide 28 inflating. Under these conditions, base flange 42 will similarly increase the pull-out strength of insert 24 or 24A as described above.

Although inserts 24 and 24A have been described as installed in packboard 16 those skilled in the art will understand that inserts 24 and 24A have broader applicability. That is to say these inserts can be used in any other application that requires an insert. Those skilled in the art will also recognize that although insert 24A is shown as located within lateral panel 20 insert 24A can also be located in rear panel 18.

As demonstrated above, a non-limiting reason to use inserts 24 or 24A in a composite panel such as those forming packboard 16 is to increase the pull-out strength of insert 24 and 24A. Additionally, the unitary construction of inserts 24 or 24A can also streamline production thus saving time and cost. Thickness t₁ of base flange 42 can also be designed to be thin enough have a low profile so as not to interfere with positioning slide 28 within packboard 16 or to interfere with positioning packboard 16 within compartment 14.

Discussion of Possible Embodiments

The following are non-exclusive descriptions of possible embodiments of the present invention.

An insert according to an exemplary embodiment of this disclosure among other possible things includes a shaft including a first end; a second end; and an external surface and an internal surface extending between the first end and the second end, the internal surface defining a passage through the shaft; a base flange located at the first end of the cylindrical shaft and having a first diameter; a first disc member having a second diameter smaller than the first diameter and located at the second end of the cylindrical shaft; and a second disc member having a third diameter smaller than the first diameter and located on the cylindrical shaft between the base flange and the first disc member.

The insert of the preceding paragraph can optionally include, additionally and/or alternatively, any one or more of the following features, configurations and/or additional components:

A further embodiment of the insert, wherein the base flange and the second disc member can abut each other.

A further embodiment of the insert, wherein a vent can extend the base flange in a direction generally parallel to the passage.

A further embodiment of the insert, wherein the second diameter can be substantially equal to the third diameter.

A further embodiment of the insert, wherein the first disc member can have a frustoconical shape that can be tapered towards the second disc member.

A further embodiment of the insert, wherein the first passage of the shaft can be threaded.

A further embodiment of the insert, wherein the first diameter can be between approximately two times and five times the second diameter.

A structure according to an exemplary embodiment of this disclosure, among other possible things includes a composite panel comprising a first surface; second surface; and a bore extending between the first and second surfaces; an insert positioned substantially within the bore and comprising a shaft comprising a first end; a second end; and an external shaft surface and an internal shaft surface extending between the first and second ends, the internal shaft surface defining a passage through the shaft; a base flange located on the first end of the cylindrical shaft and positioned on one of the composite panel first or second surfaces and having a first diameter; a first disc member located at the second end of the shaft and having a second diameter smaller than the first diameter; and a second disc member located on the shaft between the base flange and the first disc member and having a third diameter smaller than the first diameter.

The composite structure of the preceding paragraph can optionally include, additionally and/or alternatively, any one or more of the following features, configurations and/or additional components:

A further embodiment of the composite structure, wherein the second diameter can be substantially equal to the third diameter.

A further embodiment of the composite structure, wherein the composite panel can be formed from stacked plies of solid laminate that can surround a core material.

A further embodiment of the composite structure, wherein the solid laminate can be formed from a material selected from the group consisting of: graphite fiber, glass fiber, boron fiber, silicon carbide fiber, epoxy composite, polyimide composite, aluminum composite, titanium composite, alumina, composite, and combinations thereof.

A further embodiment of the composite structure, wherein the structure can further include a void defined by an internal surface of the composite panel, the first and second internal disc members, and a portion of the external surface of the external shaft surface extending between the first and second disc members; and a potting material disposed within the void.

A further embodiment of the composite structure, wherein an external surface of the first internal disc member can be substantially flush with the first surface of the composite panel.

A further embodiment of the composite structure, wherein the first disc member can have a frustoconical shape and is tapered towards the second disc member.

An emergency evacuation slide assembly for an aircraft according to an exemplary embodiment of this disclosure, among other possible things includes a packboard compartment comprising: a rear panel having an external surface and an internal surface; a plurality of lateral panels attached to the rear panel, each of the lateral panels having an external surface and an internal surface; and a fabric cover attached to the plurality of lateral panels forming a front surface of the packboard compartment; and a bore extending between the external and internal surfaces; an insert positioned substantially within the bore and comprising: a shaft comprising: a first end; a second end; and an external shaft surface and an internal shaft surface extending between the first and second ends, the internal shaft surface defining a passage through the shaft; a base flange located on the first end of the cylindrical shaft and positioned on one of the packboard surfaces and having a first diameter; a first disc member located at the second end of the shaft and having a second diameter smaller than the first diameter; and a second disc member located on the shaft between the base flange and the first disc member and having a third diameter smaller than the first diameter; an inflatable evacuation slide disposed within the packboard; and a threaded fastener engaging the threaded passage of the insert and extending through the fabric cover and evacuation slide to secure the cover and slide to the packboard.

The emergency evacuation slide assembly of the preceding paragraph can optionally include, additionally and/or alternatively, any one or more of the following features, configurations and/or additional components:

A further embodiment of the emergency evacuation slide assembly, wherein an external surface of the first internal disc member can be flush with a surface of the packboard.

A further embodiment of the emergency evacuation slide assembly, wherein the second diameter can be substantially equal to the third diameter.

A further embodiment of the emergency evacuation slide assembly, wherein the base flange and the second disc member can abut each other.

A further embodiment of the emergency evacuation slide assembly, wherein the first diameter is between approximately two times and five times greater than the second diameter.

A further embodiment of the emergency evacuation slide assembly, wherein the threaded passage has a 10-32 thread or a ¼-28 thread.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. An insert comprising:
a shaft comprising:
a first end;
a second end; and
an external surface and an internal surface extending between the first end and the second end, the internal surface defining a passage through the shaft;
a base flange located at the first end of the cylindrical shaft and having a first diameter;
a first disc member having a second diameter smaller than the first diameter and located at the second end of the cylindrical shaft; and
a second disc member having a third diameter smaller than the first diameter and located on the cylindrical shaft between the base flange and the first disc member.

2. The insert of claim 1, wherein the base flange and the second disc member abut each other.

3. The insert of claim 2, wherein a vent extends through the base flange in a direction generally parallel to the passage.

4. The insert of claim 1, wherein the second diameter is substantially equal to the third diameter.

5. The insert of claim 1, wherein the first disc member has a frustoconical shape and is tapered towards the second disc member.

6. The insert of claim 1, wherein the passage of the shaft is threaded.

7. The insert of claim 1, wherein the first diameter is between approximately two times to five times greater than the second diameter.

8. A structure comprising:
a composite panel comprising:
a first surface;
a second surface; and
a bore extending between the first surface and second surface;
an insert positioned substantially within the bore and comprising:
a shaft comprising:
a first end;
a second end; and
an external shaft surface and an internal shaft surface extending between the first and second ends, the internal shaft surface defining a passage through the shaft;
a base flange located on the first end of the cylindrical shaft and positioned on one of the composite panel first or second surfaces and having a first diameter;
a first disc member located at the second end of the shaft and having a second diameter smaller than the first diameter; and
a second disc member located on the shaft between the base flange and the first disc member and having a third diameter smaller than the first diameter.

9. The composite structure of claim 8, wherein the second diameter is substantially equal to the third diameter.

10. The composite structure of claim 8, wherein the composite panel is formed from stacked plies of solid laminate that surround a core material.

11. The composite structure of claim 10, wherein the solid laminate is formed from a material selected from the group consisting of: graphite fiber, glass fiber, boron fiber, silicon carbide fiber, epoxy composite, polyimide composite, aluminum composite, titanium composite, alumina, composite, and combinations thereof.

12. The composite structure of claim 8, and further comprising:
a void defined by an internal surface of the composite panel, the first and second disc members, and a portion of the external shaft surface extending between the first and second disc members; and
a potting material disposed within the void.

13. The composite structure of claim 8, wherein the first disc member is substantially flush with the first surface of the composite panel.

14. The composite structure of claim 8, wherein the first disc member has a frustoconical shape and is tapered towards the second disc member.

15. An emergency evacuation slide assembly for an aircraft comprising:
a packboard compartment comprising:
a rear panel having an external surface and an internal surface;
a plurality of lateral panels attached to the rear panel, each of the lateral panels having an external surface and an internal surface;
a fabric cover attached to the plurality of lateral panels and forming a front surface of the packboard compartment; and
a bore extending between the external surface and the internal surface of one of the panels;
an insert positioned substantially within the bore and comprising:
a shaft comprising:
a first end;
a second end; and
an external shaft surface and an internal shaft surface extending between the first and second ends, the internal shaft surface defining a passage through the shaft;
a base flange located on the first end of the cylindrical shaft and positioned on one of the packboard panel surfaces and having a first diameter;
a first disc member located at the second end of the shaft and having a second diameter smaller than the first diameter; and
a second disc member located on the shaft between the base flange and the first disc member and having a third diameter smaller than the first diameter;
an inflatable evacuation slide disposed within the packboard; and
a fastener engaging the passage of the insert and extending through the fabric cover and evacuation slide to secure the cover and slide to the packboard.

16. The emergency evacuation slide assembly of claim 15, wherein the first disc member is flush with a panel surface of the packboard.

17. The emergency evacuation slide assembly of claim 15, wherein the second diameter is substantially equal to the third diameter.

18. The emergency evacuation slide assembly of claim 15, wherein the base flange and the second disc member abut each other.

19. The emergency evacuation slide assembly of claim 15, wherein the first diameter is between approximately two to five times greater than the second diameter.

20. The emergency evacuation slide assembly of claim 15, wherein the passage is threaded and includes a 10-32 thread or a ¼-28 thread.
